(19) United States
(12) Patent Application Publication
(10) Pub. No.: US 2008/0065865 A1
(43) Pub. Date: Mar. 13, 2008

(54) In-use bits for efficient instruction fetch operations

(76) Inventors: Ilhyun Kim, Beaverton, OR (US); Stephan Jourdan, Portland, OR (US); Alexandre Farcy, Hillsboro, OR (US); Bret Toll, Hillsboro, OR (US)

Correspondence Address: CAVEN & AGHEVLI;c/o INTELLEVATE, P.O. BOX 52050, MINNEAPOLIS, MN, 55402, US

(21) Appl. No.: 11/518,103

(22) Filed: Sep. 8, 2006

(51) Int. Cl. G06F 9/44

(52) U.S. Cl. 712/225

(57) ABSTRACT

Methods and apparatus to perform efficient instruction fetch operations are described. In an embodiment, one or more bits are utilized to determine when to modify an entry in a storage unit of a processor. Other embodiments are also described.

### BACKGROUND

The present disclosure generally relates to the field of electronics. More particularly, an embodiment of the invention relates to techniques for utilizing in-use bits for efficient instruction fetch operations in a processor.

To improve performance, some processors may utilize a storage unit inside the processor. For example, an instruction cache may be used to temporarily store data corresponding to an instruction and an instruction translation lookaside buffer (ITLB) may be used to translate an instruction pointer address into a physical instruction address. In some situations, one or more entries of an instruction cache or an ITLB may need to be removed or replaced, e.g., to reclaim or modify a portion of the corresponding storage unit. However, when an entry is replaced or removed from an instruction cache or an ITLB may have an impact on processor performance or operational correctness.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 7, and 8 illustrate block diagrams of embodiments of computing systems, which may be utilized to implement various embodiments discussed herein.

FIG. 2 illustrates a block diagram of portions of a processor core and other components of a computing system, according to an embodiment of the invention.

FIGS. 3-6 illustrate flow diagrams of various methods in accordance with some embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

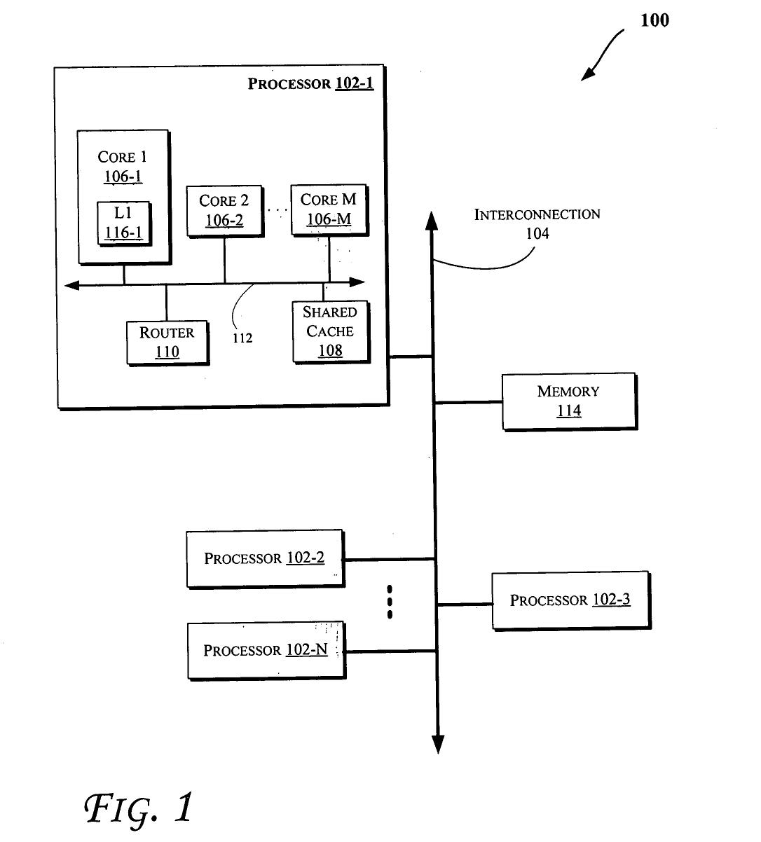

Some of the embodiments discussed herein may be utilized to perform efficient instruction fetch operations. In an embodiment, an in-use field for each entry of a storage unit (such as an instruction cache and/or an ITLB) may be utilized to determine when to modify that entry. For example, if the in-use bit indicates that the corresponding entry is unused, that entry may be removed or replaced without further latency. Such techniques may allow for improved performance during instruction fetch operations in various computing systems, such as the computing systems discussed with reference to FIGS. 1 and 7-8. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

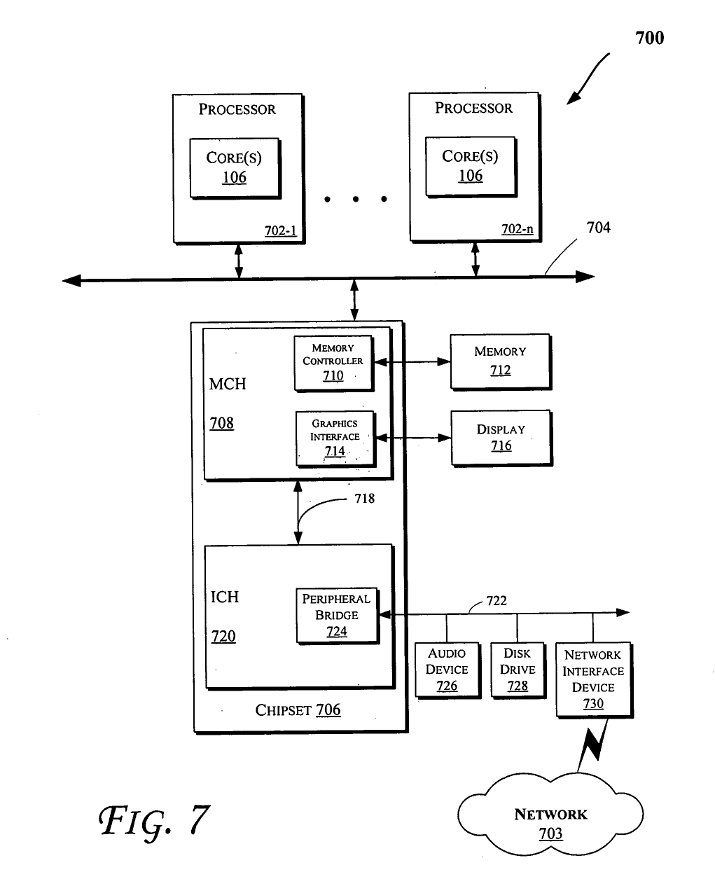

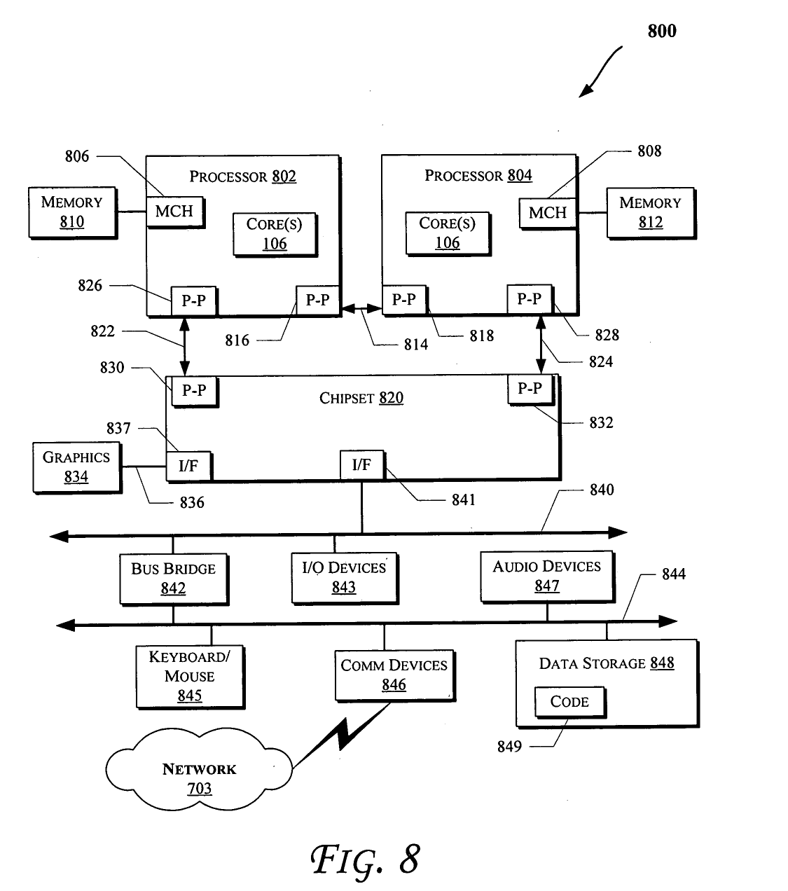

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 7 and 8), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache (116-1) (generally referred to herein as “L1 cache 116”).

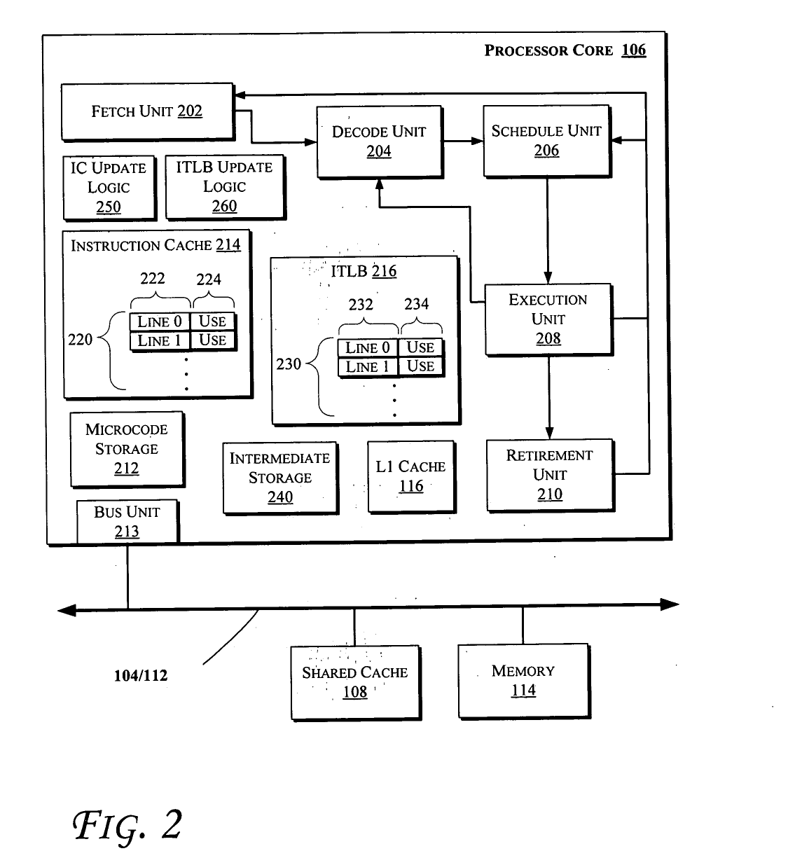

FIG. 2 illustrates a block diagram of portions of a processor core 106 and other components of a computing system, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

As illustrated in FIG. 2, the processor core 106 may include a fetch unit 202 to fetch instructions for execution by the core 106. The instructions may be fetched from any storage devices such as the memory 114 and/or the memory devices discussed with reference to FIGS. 7 and 8. The core 106 may also include a decode unit 204 to decode the fetched instruction. For instance, the decode unit 204 may decode the fetched instruction into a plurality of uops (micro-operations). Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit, such as a memory execution unit, an integer execution unit, a floating-point execution unit, or other execution units. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. The core 106 may also include a retirement unit 210. The retirement unit 210 may retire executed instructions (e.g., in order) after they are committed. In an embodiment, retirement of the executed instructions may result in processor state being committed from the execution of the instructions, physical registers used by the instructions being de-allocated, etc.

The core 106 may additionally include a storage unit 212 (which may be a microcode read-only memory (uROM) in an embodiment) to store microcode. The microcode stored in the storage unit 212 may be used to configure various hardware components of the core 106. In an embodiment, the microcode stored in the storage unit 212 may be loaded from another component in communication with the processor core 106, such as a computer-readable medium or other storage device discussed with reference to FIGS. 7 and 8. The core 106 may also include a bus unit 213 to allow communication between components of the processor core 106 and other components (such as the components discussed with reference to FIG. 1) via one or more buses (e.g., buses 104 and/or 112).

Further, the core 106 may include an instruction cache 214 to store data corresponding to one or more instructions and/or traces of instructions that have been fetched (e.g., by the fetch unit 202). In an embodiment, the instruction cache 214 may store data corresponding to decoded instructions (e.g., including instructions that are decoded by the decode unit 204). Also, the core 106 may include an ITLB 216 to translate an instruction pointer address (such as a next-instruction pointer address) into a physical instruction address (e.g., an address of an entry in the shared cache 108). For example, in case of a miss in the instruction cache 214, the fetch unit 202 may utilize data stored in the ITLB 216 to fetch the corresponding data from another memory device (such as the shared cache 108 and/or the memory 114).

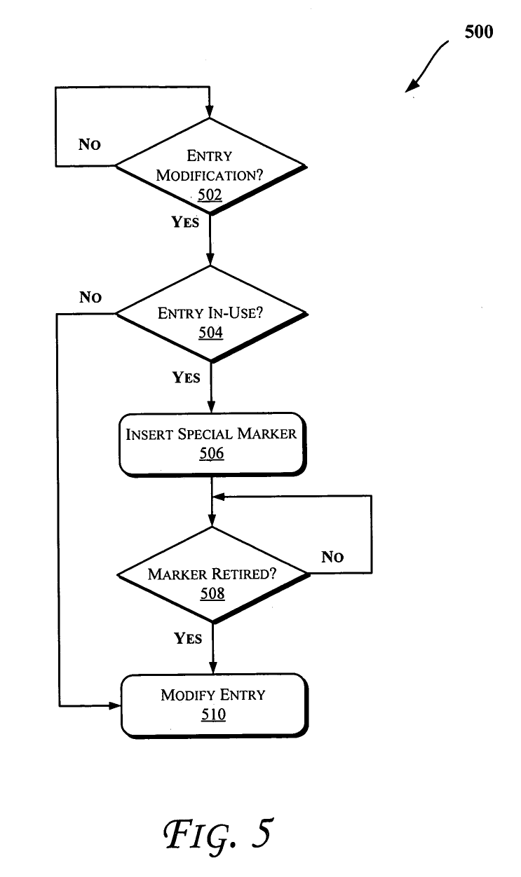

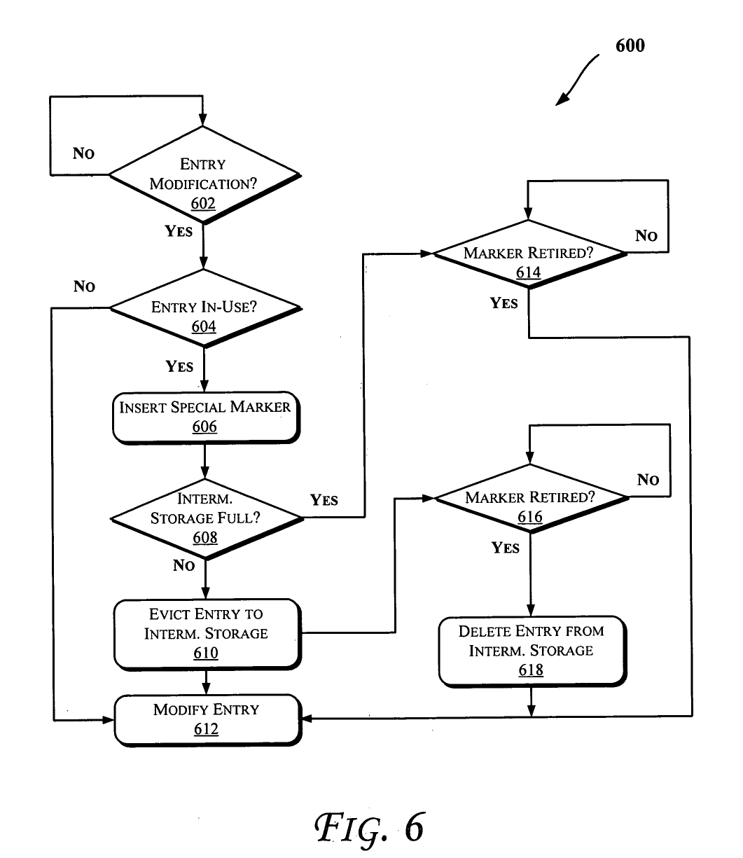

As shown in FIG. 2, the cache 214 may include one or more entries 220. Each entry 220 may include a cache line portion 222 (that may store data corresponding to a fetched and/or decoded instruction including uops) and an in-use field 224 (which may be a single bit in an embodiment). Also, the ITLB 216 may include one or more entries 230. Each entry 230 may include a buffer line portion 232 (that may store data that may be used to translate an instruction pointer address) and an in-use field 234 (which may be a single bit in an embodiment). As will be further discussed herein, e.g., with reference to FIGS. 5 and 6, the in-use fields 224 and/or 234 may be used to determine when to modify an entry in the cache 214 and/or ITLB 216, respectively. The core 106 may additionally include an intermediate storage 240 to store data corresponding to evicted entries from the cache 214 and/or ITLB 216. The core 106 may further include an instruction cache (IC) update logic 250 to update the fields 224 and an ITLB update logic 260 to update the fields 234. In various embodiments, the L1 cache 116 may include the instruction cache 214 and/or ITLB 216.

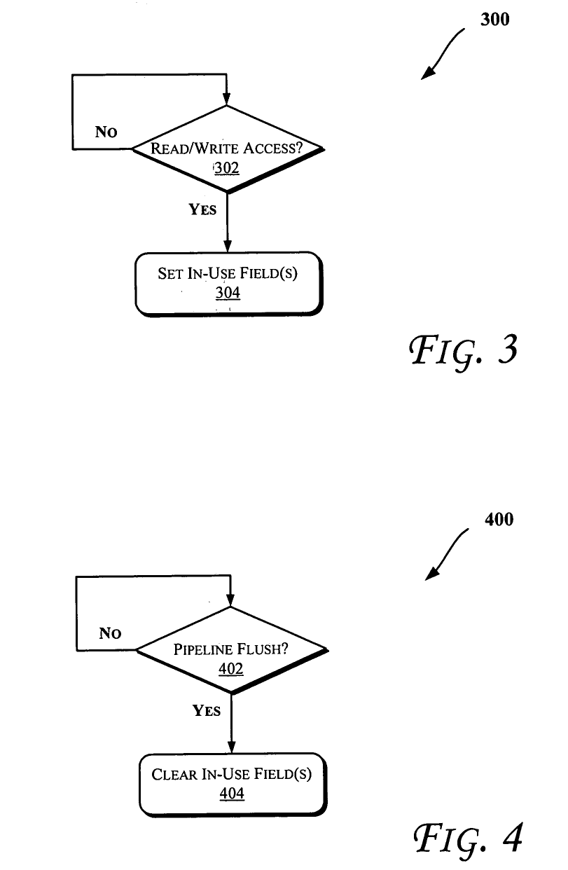

FIG. 3 and FIG. 4 illustrate flow diagrams of methods 300 and 400 to set or clear in-use fields 224 or 234 of the instruction cache 214 or the ITLB 216 of FIG. 2, respectively, according to some embodiments. In some embodiments, various components discussed with reference to FIGS. 1-2 and 7-8 may be utilized to perform one or more of the operations discussed with reference to FIGS. 3-4.

Referring to FIGS. 1-3, at an operation 302, the logics 250 or 260 may determine whether a read or write access has occurred on an entry 220 or 230, respectively. If an access has occurred, the corresponding in-use field (e.g., 224 and/or 234) may be set at operation 304, e.g., by logics 250 and/or 260.

Referring to FIGS. 1-4, at an operation 402, the logics 250 or 260 may determine whether a pipeline flush has occurred (e.g., a flush of the whole pipeline or alternatively one or more components of the core 106 and/or processor 102). If a data in the pipeline of a corresponding processor core (or processor) has been flushed, the in-use fields (e.g., 224 and/or 234) may be cleared at operation 404, e.g., by logics 250 and/or 260. Although, FIGS. 3 and 4 discuss setting and clearing the in-use fields 224 and 234, alternative implementations may be used, e.g., by utilizing more than one bit of data for the fields 224 and/or 234. Also, at operation 304 the in-use field(s) may be cleared and at operation 404 the in-use field(s) may be set instead.

FIGS. 5 and 6 illustrate flow diagrams of methods 500 and 600 which may be used to modify an entry in a storage unit such as the instruction cache 214 and/or ITLB 216 of FIG. 2, according to some embodiments. In some embodiments, various components discussed with reference to FIGS. 1-2 and 7-8 may be utilized to perform one or more of the operations discussed with reference to FIGS. 5-6.

Referring to FIGS. 1-5, at an operation 502, it may be determined whether an entry (e.g., 220 or 230, respectively) is to be modified (e.g., replaced or removed). For example, an entry may be replaced or removed to reclaim a portion of the cache 214 and/or ITLB 216. In an embodiment, the fetch unit 202 may attempt to fetch data corresponding to an instruction from the memory 114 and store the data in one of the entries 220 and/or 230 of the instruction cache 214 and/or ITLB 216, respectively, at operation 502. In another example, the retirement unit 210 may upon retirement of an instruction remove the corresponding entry from the intermediate storage unit 240, instruction cache 214, and/or ITLB 216.

At an operation 504, a component of the core 106 (e.g., the fetch unit 202) may determine whether the entry of operation 502 is in use by referring to the corresponding in-use field (e.g., fields 224 and/or 234). If the entry is in use (e.g., a corresponding bit of the fields 224 and/or 234 is set or cleared depending on the implementation), at an operation 506, a special marker instruction (or uop) may be inserted into the processor core 106 pipeline (e.g., by the fetch unit 202 and/or corresponding logics 250 or 260). Once at operation 508, the special marker instruction is retired by the retirement unit 210, the entry of operation 502 may be modified (e.g., replaced or removed) at operation 510 (e.g., by a component of the processor core 106 such as the fetch unit 202).

As shown in FIG. 5, if at operation 504, it is determined that the entry of operation is unused, the method 500 may continue at operation 510. The latter situation may result in improved performance, in part, because operations 506 and 508 may be avoided in some situations.

Referring to FIGS. 1-6, at an operation 602, it may be determined whether an entry (e.g., 220 or 230, respectively) is to be modified (e.g., replaced or removed) such as discussed with reference to operation 502. At an operation 604, a component of the core 106 (e.g., the fetch unit 202) may determine whether the entry of operation 602 is in use by referring to the corresponding in-use field (e.g., fields 224 and/or 234). If the entry is in use (e.g., a corresponding bit of the fields 224 and/or 234 is set or cleared depending on the implementation), at an operation 606, a special marker instruction (or uop) may be inserted into the processor core 106 pipeline (e.g., by the fetch unit 202 and/or corresponding logics 250 or 260).

At an operation 608, if the intermediate storage unit 240 is not full, the entry of operation 602 may be evicted to the intermediate storage unit 240. For example, an entry (e.g. entries 220 and/or 230) may be copied to the intermediate storage unit 240 and the corresponding data deleted from the source device (e.g., cache 214 and/or ITLB 216, respectively) at operation 610. At an operation 612, the evicted entry may be modified, for example, such as discussed with reference to operation 510.

At operation 608, if the storage unit 240 is full, once at operation 614 the special marker instruction of operation 606 is retired by the retirement unit 210, the entry of operation 602 may be modified (e.g., replaced or removed) at operation 612 (e.g., by a component of the processor core 106 such as the fetch unit 202). Also, after operation 610, once at operation 616 the special marker instruction of operation 606 is retired by the retirement unit 210, the corresponding entry evicted to the storage unit 240 may be deleted and the method 600 may resume at operation 612 to modify the entry of operation 602.

As shown in FIG. 6, if at operation 604, it is determined that the entry of operation is unused, the method 600 may continue at operation 612. The latter situation may result in improved performance, in part, because operations 606, 608, 610, 614, 616, and 618 may be skipped in some situations. As a result, fewer evictions may be made into the intermediate storage unit 240, which may in turn allow for a smaller intermediate storage unit 240 and/or improved performance not having to wait for the retirement of the special marker instruction of operation 606.

In an embodiment, the in-use fields (e.g., 224 or 234) may allow for an indication of whether a corresponding entry may have an instruction pending instruction in the pipeline of the core 106. More particularly, if an in-use field indicates that the corresponding entry is unused, then that entry may be modified without having to wait for the pipeline to drain or performing operations associated with inserting a special marker instruction into the pipeline and waiting for the special instruction to retire. Moreover, in embodiments that evict an entry to an intermediate storage unit (such as the embodiments discussed with reference to operations 608, 610, 614, 616, or 618 of FIG. 6), the size of the intermediate storage unit 240 may be reduced (or the intermediate storage unit 240 may be removed in an embodiment).

FIG. 7 illustrates a block diagram of a computing system 700 in accordance with an embodiment of the invention. The computing system 700 may include one or more central processing unit(s) (CPUs) 702 or processors that communicate via an interconnection network (or bus) 704. The processors 702 may include a general purpose processor, a network processor (that processes data communicated over a computer network 703), or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. In an embodiment, one or more of the processors 702 may be the same or similar to the processors 102 of FIG. 1. For example, one or more of the processors 702 may include one or more of the cores 106 and/or shared cache 108. Also, the operations discussed with reference to FIGS. 1-6 may be performed by one or more components of the system 700.

A chipset 706 may also communicate with the interconnection network 704. The chipset 706 may include a memory control hub (MCH) 708. The MCH 708 may include a memory controller 710 that communicates with a memory 712 (which may be the same or similar to the memory 114 of FIG. 1). The memory 712 may store data, including sequences of instructions, that may be executed by the CPU 702, or any other device included in the computing system 700. In one embodiment of the invention, the memory 712 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple CPUs and/or multiple system memories.

The MCH 708 may also include a graphics interface 714 that communicates with a display device 716. In one embodiment of the invention, the graphics interface 714 may communicate with the display device 716 via an accelerated graphics port (AGP). In an embodiment of the invention, the display 716 (such as a flat panel display) may communicate with the graphics interface 714 through, for example, a signal converter that translates a digital representation of an image stored in a storage device such as video memory or system memory into display signals that are interpreted and displayed by the display 716. The display signals produced by the display device may pass through various control devices before being interpreted by and subsequently displayed on the display 716.

A hub interface 718 may allow the MCH 708 and an input/output control hub (ICH) 720 to communicate. The ICH 720 may provide an interface to I/O device(s) that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the CPU 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more disk drive(s) 728, and a network interface device 730 (which is in communication with the computer network 703). Other devices may communicate via the bus 722. Also, various components (such as the network interface device 730) may communicate with the MCH 708 in some embodiments of the invention. In addition, the processor 702 and the MCH 708 may be combined to form a single chip. Furthermore, a graphics accelerator may be included within the MCH 708 in other embodiments of the invention.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 8 illustrates a computing system 800 that is arranged in a point-to-point (PtP) configuration, according to an embodiment of the invention. In particular, FIG. 8 shows a system where processors, memory, and input/output devices are interconnected by a number of point-to-point interfaces. The operations discussed with reference to FIGS. 1-7 may be performed by one or more components of the system 800.

As illustrated in FIG. 8, the system 800 may include several processors, of which only two, processors 802 and 804 are shown for clarity. The processors 802 and 804 may each include a local memory controller hub (MCH) 806 and 808 to enable communication with memories 810 and 812. The memories 810 and/or 812 may store various data such as those discussed with reference to the memory 712 of FIG. 7.

In an embodiment, the processors 802 and 804 may be one of the processors 702 discussed with reference to FIG. 7. The processors 802 and 804 may exchange data via a point-to-point (PtP) interface 814 using PtP interface circuits 816 and 818, respectively. Also, the processors 802 and 804 may each exchange data with a chipset 820 via individual PtP interfaces 822 and 824 using point-to-point interface circuits 826, 828, 830, and 832. The chipset 820 may further exchange data with a graphics circuit 834 via a graphics interface 836, e.g., using a PtP interface circuit 837.

At least one embodiment of the invention may be provided within the processors 802 and 804. For example, one or more of the cores 106 of FIGS. 1-2 may be located within the processors 802 and 804. Other embodiments of the invention, however, may exist in other circuits, logic units, or devices within the system 800 of FIG. 8. Furthermore, other embodiments of the invention may be distributed throughout several circuits, logic units, or devices illustrated in FIG. 8.

The chipset 820 may communicate with a bus 840 using a PtP interface circuit 841. The bus 840 may communicate with one or more devices, such as a bus bridge 842 and I/O devices 843. Via a bus 844, the bus bridge 842 may communicate with other devices such as a keyboard/mouse 845, communication devices 846 (such as modems, network interface devices, or other communication devices that may communicate with the computer network 703), audio I/O device 847, and/or a data storage device 848. The data storage device 848 may store code 849 that may be executed by the processors 802 and/or 804.

In various embodiments of the invention, the operations discussed herein, e.g., with reference to FIGS. 1-8, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-8.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A processor comprising:
a storage unit having an entry to store data corresponding to an instruction; and
a first logic to modify the entry based on a value of an in-use field corresponding to the entry.

2. The processor of claim 1, wherein the storage unit comprises one or more of an instruction cache or an instruction translation lookaside buffer.

3. The processor of claim 1, wherein the storage unit comprises an in-use field for each entry stored in the storage unit.

4. The processor of claim 1, further comprising a second logic to update the value of the in-use field in response to one or more of: a read access to the entry, a write access to the entry, or a flush of data in a pipeline of the processor.

5. The processor of claim 1, further comprising an intermediate storage unit to store data corresponding to an evicted entry of the storage unit.

6. The processor of claim 1, further comprising a second logic to decode the instruction into one or more micro-operations, wherein the one or more micro-operations are stored in the storage unit.

7. The processor of claim 1, further comprising a memory, wherein the first logic modifies the entry with data stored in a memory.

8. The processor of claim 1, further comprising a shared cache, wherein the data corresponding to the instruction comprises a physical address of an entry in the shared cache that corresponds to the instruction.

9. The processor of claim 8, wherein the shared cache comprises one or more of a mid-level cache, a last level cache, or combinations thereof.

10. The processor of claim 1, further comprising a level 1 cache that comprises the storage unit.

11. The processor of claim 1, further comprising a plurality of processor cores, wherein at least one of the plurality of processor cores comprises one or more of the storage unit or the first logic.

12. The processor of claim 1, wherein one or more of the first logic, the storage unit, a plurality of processor cores, or a shared cache are on a same integrated circuit die.

13. A method comprising:
storing data corresponding to an instruction in an entry of a memory unit of a processor core;
determining whether the entry is unused; and
modifying the entry after an indication that the entry is unused.

14. The method of claim 13, wherein determining whether the entry is unused comprises determining a value stored in an in-use field corresponding to the entry.

15. The method of claim 14, further comprising updating the value of the in-use field in response to one or more of: a read access to the entry, a write access to the entry, or a flush of data in a pipeline of the processor core.

16. The method of claim 13, further comprising inserting a special marker instruction in a pipeline of the processor core after determining that the entry is in use.

17. The method of claim 16, further comprising modifying the entry after the special marker instruction retires.

18. The method of claim 13, further comprising storing data corresponding to an evicted entry of the memory unit in an intermediate storage unit.

19. The method of claim 18, further comprising deleting the data corresponding to the evicted entry from the intermediate storage unit after a corresponding marker instruction retires.

20. A computing system comprising:
a memory to store data corresponding to an instruction;
a first logic to fetch the instruction from the memory and store it in a cache, wherein each entry of the cache comprises an in-use bit to indicate whether a corresponding entry of the cache is unused.

21. The system of claim 20, wherein the cache comprises an instruction cache.

22. The system of claim 20, further comprising an instruction translation lookaside buffer to store a physical address of the instruction, wherein each entry of the instruction translation lookaside buffer comprises an in-use bit to indicate whether a corresponding entry of the instruction translation lookaside buffer is unused.

23. The system of claim 22, further comprising a shared cache, wherein the physical address of the instruction corresponds to an entry in the shared cache.

24. The system of claim 23, wherein the shared cache comprises one or more of a mid-level cache, a last level cache, or combinations thereof.

25. The system of claim 20, further comprising a second logic to update the value of the in-use bit in response to one or more of: a read access to a corresponding entry, a write access to a corresponding entry, or a flush of data in a pipeline of a processor that comprises one or more of the first logic or the cache.

26. The system of claim 20, further comprising an intermediate storage unit to store data corresponding to an evicted entry of the cache.

27. The system of claim 20, further comprising a level 1 cache that comprises the cache.

28. The system of claim 20, further comprising a plurality of processor cores, wherein at least one of the plurality of processor cores comprises one or more of the cache or the first logic.

29. The system of claim 20, further comprising an audio device coupled to the processor core.

30. The system of claim 20, wherein one or more of the first logic, the cache, a plurality of processor cores, or a shared cache are on a same integrated circuit die.
